(19) United States
(12) Patent Application Publication
(10) Pub. No.: US 2013/0325890 A1
(43) Pub. Date: Dec. 5, 2013

(54) LEVERAGING PERSISTED DATA QUERIES IN STREAM-BASED COMPLEX EVENT PROCESSING

(71) Applicant: Jeffrey Vaught, Batavia, OH (US)

(72) Inventor: Jeffrey Vaught, Batavia, OH (US)

(73) Assignee: CA, INC., Islandia, NY (US)

(21) Appl. No.: 13/485,249

(22) Filed: May 31, 2012

(51) Int. Cl. G06F 17/30

(52) U.S. Cl. 707/759; 707/E17.014

(57) ABSTRACT

Persisted data queries are leveraged to generate complex event processing rules for application to a real-time data stream. The method generates a persisted data query based on defined criteria; validates the persisted data query using stored persisted data; and converts the validated persisted data query to a CEP rule. The method may utilize common database querying tools such as XQuery to generate the persisted data query. The persisted data query is executed against historical unprocessed event data stored as persisted data. The results of the persisted data query are analyzed to determine if the persisted data query produces the desired results. The persisted data query is converted to a CEP rule when the desired results are produced.

### BACKGROUND

The present disclosure relates generally to infrastructure and operations management, and more particularly, to a method for using persisted data queries in complex event processing.

Complex event processing (CEP) is a method utilized to detect complex patterns in streams of events. For example, CEP can be used to monitor network traffic in order to detect patterns from seemingly random events within network traffic. Patterns identified by CEP engines may be indicative of security threats, or unauthorized use, for example . The patterns are identified based on CEP rules which provide the parameters of the pattern of interest.

### BRIEF SUMMARY

An aspect of the present disclosure includes a method for generating complex event processing (CEP) rules that comprises: generating a persisted data query based on defined criteria; validating the persisted data query using stored persisted data; and converting the validated persisted data query to a CEP rule.

Another aspect of the present disclosure includes computer program product comprising a computer readable storage medium having computer readable program code embodied therewith. The computer readable program code comprises: computer readable program code configured to generate a persisted data query based on defined criteria; computer readable program code configured to validate the persisted data query using stored persisted data; and computer readable program code configured to convert the validated persisted data query to a CEP rule.

### BRIEF DESCRIPTION OF THE DRAWINGS

FIG. 1 illustrates a flow diagram of the process for performing an embodiment of the present disclosure.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented as entirely hardware, entirely software (including firmware, resident software, micro-code, etc.) or combined software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CDROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VL3.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

An aspect of the present disclosure is a method for leveraging the conventional database querying tools to develop CEP rules that yield desired results without requiring the conventional iterative deploy-and-test process described above.

Another aspect of the present disclosure is a method for leveraging persisted data queries in complex event processing by generating event queries used for performing event searches on all historical events, or on specific connector event sources, to analyze events and detect event patterns, storing event searches as policies that can be executed at any time to view the most recent search results, and creating and deploying CEP policies that detect patterns in real-time (based on historical event searches) and perform actions on events. The robust event search of the present disclosure allows tracking of all events and deploying policies so that a manageable set of actionable conditions can be maintained and converted to alerts for escalation and inclusion in alert queues.

Within the context of the present disclosure, persisted data is intended to refer to stored historical data relating to past stream data. Stream data refers to data present in a data stream such as data packets in network traffic.

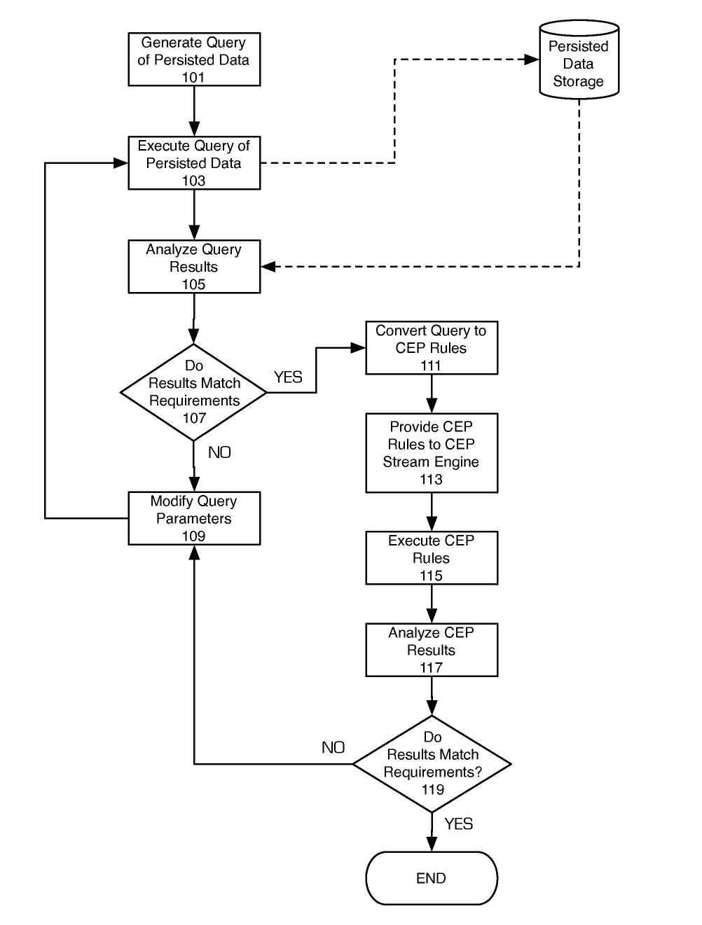

Referring to FIG. 1, an embodiment of the present disclosure begins with the generation of a query of persisted data in step 101. Persisted data is historical complex event data that has not been processed. In other words, raw event data prior to processing. The query is formulated to retrieve data from a persisted data storage, such as a database, which satisfies a set of parameters or requirements. The query is executed in step 103. After execution of the query, the results of the query are analyzed in step 105. If the results of the query do not match the design requirements in step 107, the process proceeds to step 109, otherwise the process proceeds to step 111.

At step 109, the parameters of the query are modified, and the process returns to step 103.

As noted above, if the query results match the design requirements in step 107, the process proceeds to step 111, where the query is converted to CEP rules. The conversion may range from minor syntax and semantic changes to more complex programming. The specific details of the conversion are dependent on the query and CEP languages used. The newly created CEP rules are provided to the CEP stream engine in step 113. The CEP rules are executed in the CEP stream engine in step 115 to test the CEP rules in a deployed setting.

The results of the testing performed in step 115 are analyzed in step 117. If the results of the testing match the design requirements in step 119, the process ends with a final CEP rule. However, if the results of the testing do not match the design requirements in step 119, the process returns to step 109 where the parameters of the persisted data query are modified. As noted above, once modified, the new query is executed in step 103 and the process proceeds from thereon as described above.

The persisted data query can be formed using any well known persisted data querying tools, such as SQL, XQuery, and other similar tools. Likewise, the CEP rules can be formed using tools such as JBOSS Drools CEP.

The above-described method, as well as other methods encompassed by the present disclosure, can be implemented as a software product operating on one or more computer systems. Additionally, the computer systems executing the method of the present disclosure may be configured to maintain the persisted data in a storage device disposed thereon, such as solid-state storage devices, magnetic media, opti-magnetic media, and optical media. The stream events may be received by the computer system as well.

Alternatively, the methods of the present disclosure may be executed by one or more first computer systems operable as workstations, while the persisted data may be stored in dedicated computer systems operating as servers. Likewise, the stream events may be received and processed by a separate server.

Where the implementation of the present disclosure involves multiple computer systems, the individual computer systems can be networked using any of the commonly employed networking protocols, such as TCP/IP, Token Ring, wired Ethernet, and WiFi protocols including 802.11(a), (b), (g) and (n).

The computer systems executing embodiments of the present disclosure, whether operating as workstations or servers, include one or more processors electrically coupled to volatile memory and non-volatile computer-readable storage devices. Additionally, the computer systems include one or more network interfaces electrically coupled to a system bus accessible by the one or more processors, volatile memory and non-volatile computer-readable storage devices.

Moreover, computer systems operable as workstations, in the present disclosure, also include a user input interface, such as a keyboard, mouse, touchpad, trackball, microphone configured for voice recognition and text to speech implementations, and digital pen. Also, the workstations are configured with video cards coupled to a display device for displaying a graphical representation of components of the present disclosure with which a user interacts.

The described embodiments of the present disclosure are intended to be illustrative rather than restrictive, and are not intended to represent every embodiment of the present disclosure. Various modifications and variations can be made without departing from the spirit or scope of the disclosure as set forth in the following claims both literally and in equivalents recognized in law.

What is claimed is:

1. A method for generating complex event processing (CEP) rules, the method comprising:
generating a persisted data query based on defined criteria;
validating the persisted data query using stored persisted data; and
converting the validated persisted data query to a CEP rule.

2. The method as in claim 1, wherein the persisted data is historical unprocessed event data previously received and stored.

3. The method as in claim 2, wherein validating the persisted data query comprises:
executing the persisted data query on the stored persisted data;
analyzing results of the persisted data query; and
determining if the results of the persisted data query produced desired results.

4. The method as in claim 3, wherein parameters of the persisted data query are modifiable if the results of the persisted data query do not produced the desired results.

5. The method as in claim 3, wherein the persisted data query is converted to the CEP rule if the results of the persisted data query produced the desired results.

6. The method as in claim 1, wherein the persisted data query is generated using XQuery.

7. The method as in claim 1, wherein the CEP rule is generated using JBOSS Drools.

8. A computer program product comprising a computer readable storage medium having computer readable program code embodied therewith, the computer readable program code comprising:
computer readable program code configured to generate a persisted data query based on defined criteria;
computer readable program code configured to validate the persisted data query using stored persisted data; and
computer readable program code configured to convert the validated persisted data query to a CEP rule.

9. The computer program product as in claim 8, wherein the persisted data is historical unprocessed event data previously received and stored.

10. The computer program product as in claim 9, wherein computer readable program code configured to validate the persisted data query comprises:
computer readable program code configured to execute the persisted data query on the stored persisted data;
computer readable program code configured to analyze results of the persisted data query; and
computer readable program code configured to determine if the results of the persisted data query produced desired results.

11. The computer program product as in claim 10, wherein parameters of the persisted data query are modifiable if the results of the persisted data query do not produced the desired results.

12. The computer program product as in claim 10, wherein the persisted data query is converted to the CEP rule if the results of the persisted data query produced the desired results.

13. The computer program product as in claim 8, wherein the persisted data query is generated using XQuery.

14. The computer program product as in claim 8, wherein the CEP rule is generated using JBOSS Drools.
